(19) United States
(12) Patent Application Publication
(10) Pub. No.: US 2003/0055742 A1
(43) Pub. Date: Mar. 20, 2003

(54) Computer-aided configurator for configuring a plant in the basic materials industry

(75) Inventor: Heinz Hodl, Leonding (AT)

Correspondence Address: OSTROLENK FABER GERB & SOFFEN, 1180 AVENUE OF THE AMERICAS, NEW YORK, NY, 100368403

(73) Assignee: Voest-Alpine Industrienanlagenbau GmbH

(21) Appl. No.: 10/242,498

(22) Filed: Sep. 11, 2002

(30) Foreign Application Priority Data
Sep. 14, 2001 (AT) A 1450/2001

(51) Int. Cl. G06F 17/60

(52) U.S. Cl. 705/26

(57) ABSTRACT

The present invention relates to a method for the computer-aided planning of a plant in the basic materials industry, in particular a metallurgical plant and/or facility, with provision of component and/or plant data in a data structure and input of user-specific data and/or specifications via a user interface (6) by an authorized user (1) and configuration of the plant by linking user-specific data and/or specifications together with component and/or plant data present in the data structure by means of models describing plants in the basic materials industry and/or the processes used in the basic materials industry, and output of the configured product in the form of a structured configuration proposal. The present invention also relates to a configurator.

The present invention relates to a computer-aided configurator for configuring a plant in the basic materials industry, in particular a metallurgical plant and/or facility, and also to an associated method for the computer-aided planning of a plant in the basic materials industry.

There are many configurators for configuring a specific product in existence and they can be operated either offline or online.

U.S. Pat. No. 6,064,982 A1 discloses a configurator for assessing customer requirements and for the configuration of a combination of hardware (server) and software which satisfies the customer requirements in the best possible way. Here, the configuration takes place offline in an interactive product selection process, in which the customer is guided through the configuration by means of a number of input masks.

WO 96/02882 A1 discloses a generalized configuration expert system, which can be adapted to various specific configuration problems by programming the special configuration rules. For this purpose, a dedicated configuration language is used, with which the available components and their requirements are specified. The user consequently uses the ready-specified configurator via an input device for the selection of components to be configured and finished configurations are output on a display. However, as a result of the statically defined rules, this configurator very quickly reaches its limits if it is intended to configure products with components which cannot be specified by simple reciprocal requirements and mutual dependencies. This expert system is not capable of assessing the dynamic behaviour of the configured product.

It is therefore an object of the present invention to develop further a configurator corresponding to the precharacterizing clause of claim 1 and a method for the computer-aided planning of a plant in the basic materials industry, so that the components to be configured can also be specified by complex requirements and dependencies and dynamic processes can also be integrated into the configuration.

This object is achieved by the invention in the way corresponding to the configurator according to the characterizing clause of claim 1, and in the way corresponding to the computer-aided method according to claim 6.

According to one particular embodiment of the configurator according to the invention, the configuration unit has a configuration memory unit for storing data.

According to one particular embodiment of the configurator according to the invention, the configuration unit and/or the component and/or plant databank and/or the configuration memory unit and/or the user interface can be implemented on a server and/or a client, and, if appropriate, the client and server are connected to each other via a network, in particular a Virtual Private Network.

According to one particular embodiment of the configurator according to the invention, the user is connected via a workstation or a PC to the user interface of the configurator through a network.

According to one particular embodiment of the configurator according to the invention, an external interface is provided in the configurator, the external interface being connected to an expert system for executing complex computing operations or simulations and/or to an expert for the interactive input of additional data and/or specifications.

According to one particular embodiment of the configurator according to the invention, the configurator is implemented as a computer program which can be run on a server and/or a workstation or a PC.

According to one particular embodiment of the method according to the invention, the investment costs for the production and provision, and if appropriate delivery, of the plant and/or a schedule for the production and provision, and if appropriate delivery, of the plant are determined.

According to one particular embodiment of the method according to the invention, the planning comprises the production and provision, and also the installation and/or the commissioning, of the plant, with the investment costs for the installation and/or commissioning of the plant and/or a schedule for the installation and/or commissioning of the plant being determined.

According to one particular embodiment of the method according to the invention, the plant to be planned in the basic materials industry has a continuous casting plant.

According to one particular embodiment of the method according to the invention, the user inputs one or more of the following data, preferably via the user interface:

desired production output (amount of steel to be processed)

steel grades cast

ladle size

number of batches per sequence

desired width of the billet being cast

desired thickness of the billet being cast

According to one particular embodiment of the method according to the invention, one or more of the following data for the configuration of the continuous casting plant are determined, in particular calculated, in the project-planning procedure:

output of the continuous casting plant

number of billets

maximum casting speed

length of the continuous casting machine

casting radius.

According to one particular embodiment of the method according to the invention, the models used for the configuration of the continuous casting plant include at least one of the following models:

model for determining and/or optimizing the output of the continuous casting plant

model for determining and/or optimizing the number of billets

model for determining and/or optimizing the maximum casting speed

model for determining and/or optimizing the length of the continuous casting machine

model for determining and/or optimizing the casting radius

model for establishing a price, in particular for calculating the price of the plant or its components.

According to further embodiments of the method according to the invention, models for producing a simulation and/or other plant-specific models are provided. In the case of a continuous casting plant, for example, models for determining and/or optimizing the speed of the slab are used, for example models for determining and/or optimizing what is known as the length of accompanying flame cutting.

According to one particular embodiment of the method according to the invention, descriptive documents, if appropriate in the form of written tendering documents, and/or a view of the plant and/or of the components of the plant, preferably a two-dimensional and/or three-dimensional view, and/or a simulation of the plant are created for the output of the structured configuration proposal.

The invention also relates to a method for operating a configurator according to claim 14, and also a use of a configurator according to claim 15 and an e-business platform according to claims 16 and 17.

According to one particular embodiment of the invention, the steps of providing component and/or product data in a data structure, inputting user-specific data and/or specifications via a user interface by an authorized user, configuration of the product by linking user-specific data and/or specifications together with component and/or product data present in the data structure by available logical rules modelling the product and/or complex dependencies and/or algorithms, for example an iterative optimization, and/or models, for example for a simulation, and/or artificial-intelligence models, and displaying the configured product in the form of a structured configuration proposal are carried out for configuring a plant or a product, for example a continuous casting plant.

According to one embodiment of the invention, it is possible to describe the components not only by simple mutual dependencies, but also by complex relationships to one another, which can be resolved in the form of executable algorithms or simulations or on the basis of specific models. Consequently, even complex technical products can be optimally configured, which significantly aids the planning of such a product. In this case, the configuration is not confined to putting together individual components, but instead specific components or the product can also be ideally dimensioned. Furthermore, it is possible by the use of simulations to make a prediction of the product behaviour under specific conditions; in other words, the dynamic behaviour of the product is assessed. It is consequently possible in the planning phase to predict possible undesired behaviour of the product under actual conditions, whereby costs caused by mis-planning can be avoided. This benefits both the user of the configurator, through the resultant saving of time and money in the planning phase and the knowledge of the product behaviour, and a manufacturer and/or supplier or bidder through the reduction in complaints and the standardized configuration interface.

In one advantageous embodiment, the user interface is connected to the configuration unit and the component- and/or product-data structure for the exchange of data via a network and, furthermore, the configuration unit is connected to the component- and/or product-data structure and a configuration memory unit for the exchange of data.

The configuration procedure can be significantly simplified if a configuration can be executed by the configuration unit as a series of individual configuration steps and if, in at least one configuration step, the configuration unit can generate data which can be used as input data in one of the next configuration steps. Consequently, the complex configuration task can be subdivided into a number of individual substeps, which can be described more easily, and as a result more clearly, and at the same time allow a check to be kept more easily on the configuration procedure.

In a particularly favourable variant, the user interface has at least one input mask for the input of the data and/or specifications for at least one configuration step, and the result of each configuration step can be output and checked via this user interface. As a result, a standardized interface is available to the user for all inputs and checking activities, which makes it easier for the user to operate the configurator.

To make the configurator so flexible and able to be controlled by the user, it is advantageous according to one embodiment if any desired configuration step can be repeated with other user-specific data or specifications and, in at least one configuration step, a specific component or specific product can be selected by the user from the component- or product-data structure via the user interface. Consequently, in addition to the complete automatic configuration, the user has the possibility of setting specific preferences of or specifically testing different configuration variants.

According to one embodiment of the invention, it is made easier for the user to operate the configurator by it being possible for an already commenced configuration to be interrupted at any desired point and stored in a configuration memory unit and for a stored configuration to be resumed at any time at the point at which it was discontinued. Since a configuration of a complex technical product can sometimes take a very long time, it is very advantageous to be able to interrupt the configuration at any desired point and resume it at a later point in time.

Particularly advantageous embodiments are obtained if the configuration unit can be implemented on a server and/or the component and/or product databank can be implemented on a server and/or the user interface can be implemented on a server and/or a client and/or the configuration memory unit can be implemented on a server and/or the user is connected via a workstation or a PC to the user interface of the configurator through a network. This makes it possible to realize an entirely flexible system architecture which, moreover, can be easily serviced and can be expanded.

In a further very advantageous embodiment, in the configurator there is provided an external interface, which is connected to an expert system for executing complex computing operations or simulations and/or to an expert for the interactive input of additional data and/or specifications. In the case of particularly complex simulations, which require considerable computing capacity, it is very advantageous to export them to external expert systems, since, as a result, the resources of the configurator are not overstretched by a single configuration task. In cases in which the configurator cannot find a solution of its own accord, it is very advantageous if an external expert can be contacted to assist.

It is most particularly advantageous, according to an advantageous embodiment of the invention, if component and/or product data can be added and/or removed in the component- or product-data structure by the operator of the configurator and/or any authorized manufacturer and/or supplier or an administrator via a network and/or the rules, dependencies or algorithms can be adapted in the configuration unit according to the added and/or removed component and/or product data. Consequently, the volume of the component and/or product data available for configuration is completely dynamic. The configurator can consequently be extended as desired by adding additional products, for example further metallurgical facilities.

According to one particular embodiment of the invention, it is made even easier for the user to operate the configurator if a configuration can be interrupted at any point by the user and an authorized manufacturer and/or supplier or expert can be consulted for assistance via the external interface. As a result, the user is given the possibility in unclear situations of contacting the manufacturer and/or supplier or an expert in order to clarify certain things before continuing with the configuration.

According to one embodiment of the invention, it is particularly favourable for the user if a price for the finally configured product can be calculated and output and the finally configured product can be ordered directly online or in writing from the manufacturer and/or supplier and/or the operator of the configurator and/or via a sales partner. It is also very advantageous if the structured configuration proposal is converted into an inventory and at least part of the inventory is assigned a unique serial number. The user can consequently configure the technical product independently, immediately receives the price information for the finally configured product and can order the product immediately, which significantly shortens the planning and offering cycle. By allocating unique serial numbers, the history of a configured product can be reconstructed at any time.

In an advantageous configuration, the configurator is implemented as a computer program which can be run on a server, workstation or PC, which increases the flexibility, since the computer program can be altered and improved by simple means.

The configurator is used most particularly advantageously in an e-business platform, with which all the subscribers are connected to one another through the configurator via a network and in which technical plants can be planned by means of the configurator, in particular can be configured, and can be ordered directly online from the manufacturer and/or supplier and/or from the operator of the configurator and/or a sales partner. Furthermore, it is very advantageous if, in addition to the customer and sales department, other service providers, such as for example the manufacturer, supplier, logistics, accounts, maintenance, set-up, etc., are involved in the configurator and the individual service providers are in communication with one another via the e-business platform through the configurator in the planning, execution and after-sales service phases for the planned technical plant, and access the same product and/or configuration data. The configurator consequently acts as a central element over the entire lifetime, from the planning (configuration) through to the execution and servicing, of a technical plant. All persons involved can in this case access the same data and communicate directly with one another via the configurator, which significantly reduces the expenditure for the manufacturer and/or supplier and/or the user.

According to one embodiment of the invention, there is the possibility for a potential customer (user) to configure a plant and/or apparatus in the basic materials industry online, and if appropriate produce a budget price, including a description of the plant.

The working result of this configuration in this case comprises, for example:

indication of a budget price (process turn-key and/or turn-key)

determination of a plant configuration made to suit the wishes and needs of the customer

determination and output of a technical specification of the plants

determination and output of a neutral tendering specification

creation of a 3D presentation with animation

According to a preferred embodiment, the customer configures a desired plant, putting together the optimum plant components, with a corresponding technical description, and also a 3D presentation, preferably with corresponding animation, on the basis of a large number of selection options. The customer is in each case informed by the configurator of the advantages and disadvantages of the specific plant components.

According to one particular embodiment, the configurator creates, at the request of the customer, a largely neutral technical inquiry specification, which can be sent directly to other bidders.

According to a further embodiment, a price model calculates on the basis of the configured plant (process turn-key) a budget price, which is available as a basis for the customer's investment decision.

According to a further embodiment, the configurator provides the customer, on request, with budget prices for the appraisal of the turn-key plant, i.e. including water treatment and/or assembly and/or construction work, etc.

According to a further embodiment, the configurator also creates a typical project schedule. Depending on the customer's country and/or more detailed information on the choice of production of the plant components, the configurator can determine a schedule for project realization.

The following customer advantages are obtained, corresponding to the particular embodiments:

the online configuration makes it possible to produce a budget price quickly, serving as a basis for the customer's investment decision

creation of a neutral specification as a basis for an invitation to tender to a number of rival bidders

selection of the optimum plant configuration by selection of the plant components

the customer can study the components, with their advantages and a description, and configure them as desired, preferably online, in the simulation model, preferably a 3-dimensional simulation model,

The following advantages for the bidder offering such a plant to be configured or the operator of the configurator according to the invention are obtained, corresponding to the particular embodiment:

reduced pre-project costs

low personnel capacities necessary, since initial enquiries and budget price can be worked out by the customer itself

greater chances of winning an order through better and direct service to the customer

According to a particular embodiment of the invention, the following data are at least partly provided by the customer for the configuration of a continuous casting plant:

desired production output (amount of steel to be processed)

steel grades cast

ladle size

number of batches per sequence

desired width of the billet being cast

desired thickness of the billet being cast

According to one particular embodiment, the configurator determines the following characteristic values of the continuous casting plant:

output of the continuous casting plant

number of billets

maximum casting speed

length of the continuous casting machine

casting radius.

According to a further embodiment of the invention, an at least partial visual presentation of the plant is given, comprising for example:

3D presentation of the components with advantages and with partial simulation and/or

description of the components and/or

modular design:

exchange of the components for other technical solutions possible (modular design), for example:

slewing tower: butterfly/slewing pillar tower/C-type butterfly

tundish transport: carriage/slewing tower

oscillator: hydraulic/4-eccentric;

rollers: I-STAR/CSR roller/turret roller

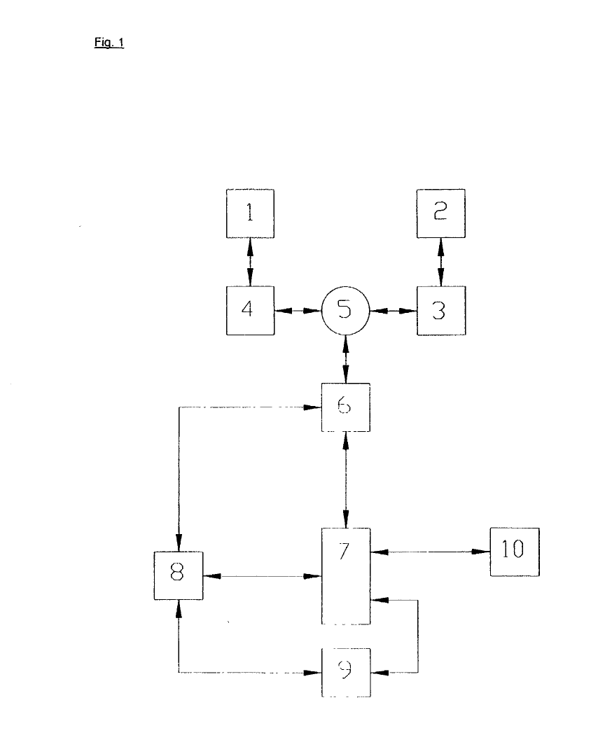

The present invention is described on the basis of FIGS. 1 to 3, which are given by way of example, do not constitute any restriction and in which:

FIG. 1 shows a schematic block diagram of a configurator according to the invention

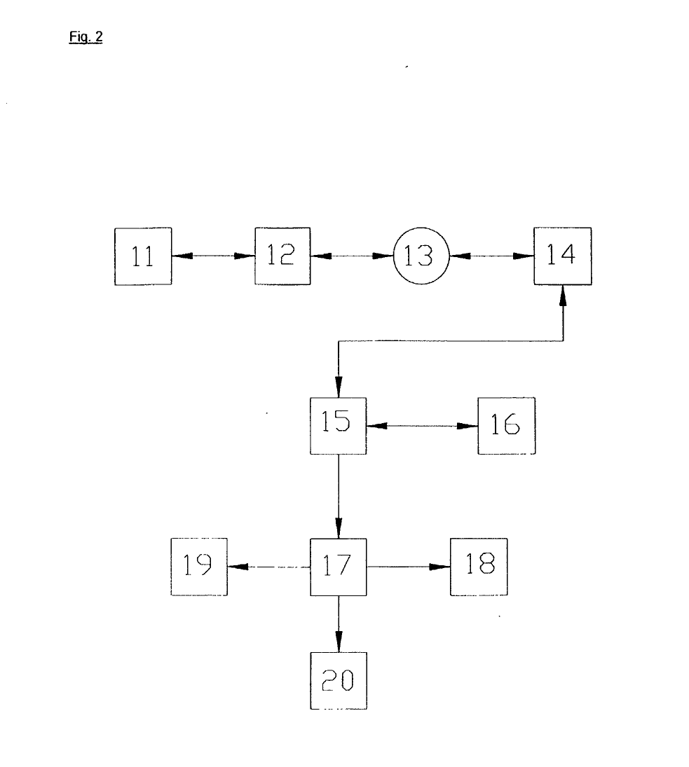

FIG. 2 shows a schematic block diagram of the procedure for planning a plant

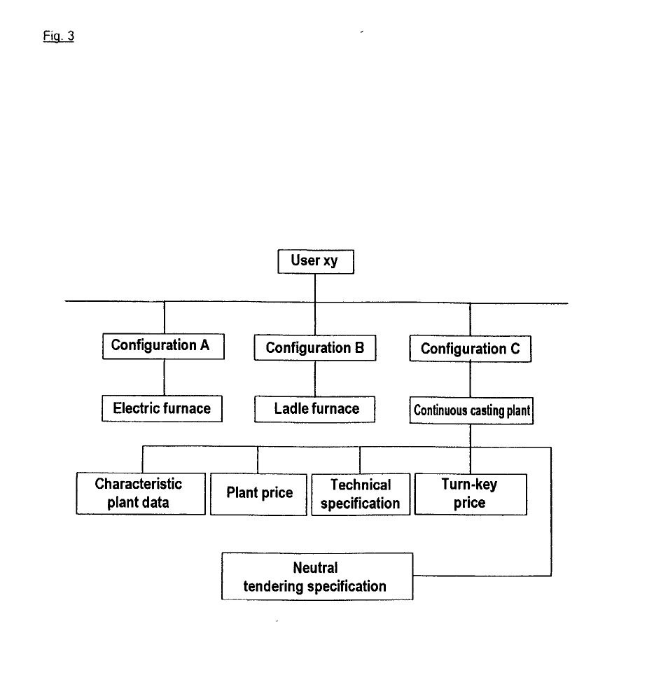

FIG. 3 shows a schematic block diagram of the result of planning a plant.

According to FIG. 1, a user 1 makes contact via a workstation 4 or a PC by interconnection of a network 5 with an input/output interface, for example a user interface 6. The input/output interface 6 is in turn in connection with a configuration unit 7. All the data decisive for the configuration and/or design of the plant are provided for the configuration unit via the input/output interface. The provision of the data can take place in this case by completing corresponding input masks. The configuration unit 7 comprises various models, algorithms, expert systems, and iterative optimization tools, which are available for designing the plant. Should it not be possible for the configuration unit to create a satisfactory configuration, an external interface 10 is available and can be used if need be to consult an external expert, for example an external expert system and/or a technical engineer. Also provided is a databank 8, which contains the exact description of the components to be configured, detailed arguments of advantages, three-dimensional and/or two-dimensional representations of the components, specifications for simulation of the components, specifications for creating a technical plant specification, specifications for calculating the cost base (process turn-key, turn-key) etc.

The configuration, for example an interrupted configuration, can be buffer-stored in a configuration memory 9 and called up again at another time. For the purpose of longer-term storage, the buffer storage can be transferred from the configuration memory 9 into the databank 8.

Also provided is a connection between the databank 8 and the input/output interface, by which an authorized manufacturer and/or supplier 2 of a component can access the data record of the databank directly, for example via a workstation 3, and can update it.

Represented in FIG. 2 is a flow chart which illustrates the function of the configurator from the viewpoint of the user.

The user 11 is connected via a workstation or a PC 12 to a network 13, which connects him, if appropriate after an identification has been provided, to the input/output interface 14 of the configurator. After answering various questions important for the configuration of the plant, and inputting the essential data, the user reaches the configuration 15. According to one embodiment, the user is in this case informed about the individual configuration steps and is given the possibility of intervening interactively in them. According to one embodiment, in this case it is possible for the user to correct again characteristic data of the desired plant which were input at the beginning and/or to choose from various configuration options. It is also possible to repeat the configuration, at least partly, and/or to interrupt it and/or to continue it again at a later point in time. The configuration 15 may in this case resort to external resources 16, for example a technical engineer and/or an external expert system. Once the configuration has been completed, the user reaches the output or display 17, which outputs or displays the plant to the user, configured to his wishes. In this case, the user is provided with the price of the plant, the level of investment, a detailed description of the plant and its components, and also, on request, corresponding presentation documents. Furthermore, it is possible to produce a simulation of the configured plant, which is likewise made available to the customer, for example for presentation purposes. It is likewise possible, at the request of the user, for a tendering specification to be created on the basis of the configuration, and made available to the user, whereby the user can request comparative offers from other manufacturers and/or suppliers.

As desired, the user can then send to the manufacturer and/or supplier of the configured plant an invitation to submit a binding tender 19, and/or place a direct order 20. For the user, it is also possible to store the created configuration 18, and if appropriate work on it further at a later point in time.

According to FIG. 3, the result of planning a plant on the basis of the method according to the invention, or by involving the configurator according to the invention, is represented, corresponding to one particular embodiment.

In this case, a user xy has planned a plant which comprises various configured and/or designed facilities in the metallurgical industry. In the schematic diagram, three typical configurations are highlighted by way of example. A configuration A comprises a configuration of an electric furnace, a configuration B comprises a configuration of a ladle furnace, and a configuration C comprises a configuration and design (including planning the delivery and/or installation and/or commissioning) of a continuous casting plant. Other configurations or designs of other plants and/or plant parts can of course be created on the basis of the method according to the invention, or involving the configurator according to the invention.

The configuration and design of the continuous casting plant includes: the characteristic data of the facility (for example the type of permanent mould used), the price (manufacture, provision) of the facility, the precise technical specification of the facility and its parts, and a turn-key price (price including delivery and setting-up through to commissioning). All these data can be output or displayed to the user. A presentation, in particular a software-controlled presentation, which includes a display and/or simulation of all the important parts of the plant/facility (configuration/design C, if appropriate with configuration A and/or configuration B) is conceivable for example as a type of output, with all the important technical and commercial data (price etc.), in particular the data describing the plant/facility, being implemented in the simulation/presentation.

On request, the user also receives a neutral tendering specification of the configured and/or designed plant/facility (configuration/design C, if appropriate with configuration A and/or configuration B).

1. Computer-aided configurator for configuring a plant in the basic materials industry, in particular a metallurgical plant and/or facility, which has the following parts:
a user interface (6) for the input of user-specific data and/or specifications by an authorized user (1), and also if appropriate for the display and/or output of data,
a component- and/or plant-data structure (8), which contains component and/or plant data available for the configuration, and
a configuration unit (7),
characterized in that
the configuration unit (7) is connected to the component- and/or plant-data structure (8), which is provided on a data carrier, in particular a physical data carrier, preferably via a network, and
the configuration unit (7) has models describing plants in the basic materials industry and/or the processes used in the basic materials industry, in particular
a.) available logical rules and/or
b.) complex dependencies and/or algorithms, for example an iterative optimization, and/or
c.) mathematical models, for example for a simulation, and/or
d.) artificial-intelligence models,
it being possible by linking component and/or plant data contained in the component- and/or plant-data structure (8) together with user-specific data and/or specifications by means of the configuration unit (7) on the basis of the stored models for the desired plant to be optimally put together and/or dimensioned and output in the form of a structured configuration proposal, preferably by means of the user interface (6).

2. Configurator according to claim 1, characterized in that the configuration unit (7) has a configuration memory unit (9) for storing data.

3. Configurator according to claim 1 or 2, characterized in that the configuration unit (7) and/or the component and/or plant databank (8) and/or the configuration memory unit (9) and/or the user interface (7) can be implemented on a server and/or a client, the client and server being connected, if appropriate, to each other via a network, in particular a Virtual Private Network.

4. Configurator according to one or more of claims 1 to 3, characterized in that the configurator has an external interface (10), and the external interface is connected to an expert system for executing complex computing operations or simulations and/or to an expert for the interactive input of additional data and/or specifications.

5. Configurator according to one or more of claims 1 to 4, characterized in that the configurator is implemented as a computer program which can be run on a server and/or a workstation or a PC.

6. Method for the computer-aided planning of a plant in the basic materials industry, in particular a metallurgical plant and/or facility, with the following steps:
provision of component and/or plant data in a data structure,
checking user authorization of a user
input of user-specific data and/or specifications via a user interface by an authorized user,
configuring the plant by linking user-specific data and/or specifications together with component and/or plant data present in the data structure with the aid of models describing plants in the basic materials industry and/or the processes used in plants in the basic materials industry, in particular
a.) available logical rules and/or
b.) complex dependencies and/or algorithms, for example an iterative optimization, and/or
c.) mathematical models, for example for a simulation, and/or
d.) artificial-intelligence models
output of the configured product in the form of a structured configuration proposal.

7. Method according to claim 6, characterized in that
the investment costs for the production and provision, and if appropriate delivery, of the plant and/or
a schedule for the production and provision, and if appropriate delivery, of the plant are determined.

8. Method according to claim 6 or 7, characterized in that
the investment costs for the installation and/or commissioning of the plant and/or
a schedule for the installation and/or commissioning of the plant are determined.

9. Method according to one or more of claims 6 to 8, characterized in that the plant to be planned in the basic materials industry has a continuous casting plant.

10. Method according to one or more of claims 6 to 9, characterized in that the user inputs one or more of the following data via the user interface:
desired production output (amount of steel to be processed)
steel grades cast
ladle size
number of batches per sequence
desired width of the billet being cast
desired thickness of the billet being cast

11. Method according to one or more of claims 6 to 10, characterized in that one or more of the following data for the configuration of the continuous casting plant are determined, in particular calculated, in the project-planning procedure:
output of the continuous casting plant
number of billets
maximum casting speed
length of the continuous casting machine
casting radius.

12. Method according to one or more of claims 6 to 11, characterized in that the models used for the configuration of the continuous casting plant include at least one of the following models:
model for determining and/or optimizing the output of the continuous casting plant
model for determining and/or optimizing the number of billets
model for determining and/or optimizing the maximum casting speed
model for determining and/or optimizing the length of the continuous casting machine
model for determining and/or optimizing the casting radius
model for establishing a price, in particular for calculating the price of the plant or its components.

13. Method according to one or more of claims 6 to 12, characterized in that descriptive documents, if appropriate in the form of written tendering documents, and/or a view of the plant and/or of the components of the plant, preferably a two-dimensional and/or three-dimensional view, and/or a simulation of the plant are created for the output of the structured configuration proposal.

14. Method for operating a configurator according to one or more of claims 1 to 5, characterized in that the configuration unit, and if appropriate the component- and/or plant-data structure, and/or the user interface are implemented on a server, and a user is authorized after logging on to put the configurator into operation.

15. Use of the configurator according to one or more of claims 1 to 5 in an e-business platform with which subscribers have access to the configurator through a virtual network and in which specific technical plants in the basic materials industry can be configured via the configurator and/or can be ordered directly online from the manufacturer and/or supplier and/or from the operator of the configurator and/or a sales partner.

16. E-business platform using a configurator according to claim 15, characterized in that, in addition to the user and the operator of the configurator, other service providers, such as for example the supplier, manufacturer, logistics, accounts, maintenance, set-up, etc., are involved in the configurator.

17. E-business platform according to claim 16, characterized in that the individual service providers are in communication with one another online via the e-business platform through the configurator in the planning, and/or production and/or delivery and/or installation and/or commissioning phase for the configured technical plant, and access the plant and/or configuration data.
